(19) United States
(12) Patent Application Publication
(10) Pub. No.: US 2009/0184912 A1
(43) Pub. Date: Jul. 23, 2009

(54) LIQUID CRYSTAL DISPLAY AND DRIVING METHOD THEREOF

(76) Inventors: Hee-Kwon Eun, Yongin-si (KR); Byung-Chang Shim, Yongin-si (KR); Dong-Wan Choi, Seoul (KR); Hyo-Sang Yang, Yongin-si (KR)

Correspondence Address: Haynes and Boone, LLP;IP Section, 2323 Victory Avenue, SUITE 700, Dallas, TX, 75219, US

(21) Appl. No.: 12/178,099

(22) Filed: Jul. 23, 2008

(30) Foreign Application Priority Data
Jan. 21, 2008 (KR) 10-2008-0006353

(51) Int. Cl. G09G 3/36

(52) U.S. Cl. 345/94; 345/211

(57) ABSTRACT

A liquid crystal display includes a voltage providing unit for providing a common voltage which is a direct-current (DC) voltage level in each of a plurality of first periods of time, in each of a plurality of second periods of time, and in each of a plurality of third periods of time, wherein each first period of time is separated from each second period of time by at least one third period of time, wherein the DC voltage levels in at least one first period of time, at least one second period of time, and at least one third period of time are different from each other.

### CROSS-REFERENCE TO RELATED APPLICATION

This application claims priority from South Korean Patent Application No. 10-2008-0006353 filed on Jan. 21, 2008 in the Korean Intellectual Property Office, the disclosure of which is incorporated herein by reference in its entirety.

### BACKGROUND OF THE INVENTION

1. Field of the Invention

The present invention relates to a liquid crystal display and a driving method thereof.

2. Description of the Related Art

Demands for large-screen and high-quality display devices are continuously increasing, and have been met by liquid crystal displays. A liquid crystal display utilizes the difference between a direct-current (DC) common voltage and a data voltage to display an image.

Recently, in order to reduce power consumption, a pulse-mode common voltage has been proposed that alternates between a high level and a low level.

If the pulse-mode common voltage is in the audio frequency range, audible noise is generated.

### SUMMARY

This section summarizes some features of the invention. Other features are described in subsequent sections. The invention is defined by the appended claims, which are incorporated into this section by reference.

Some embodiments of the present invention reduce the audible noise generated by the pulse-mode common voltage.

According to an aspect of the present invention, there is provided a liquid crystal display comprising: a voltage providing unit for providing a common voltage which is a direct-current (DC) voltage level in each of a plurality of first periods of time, in each of a plurality of second periods of time, and in each of a plurality of third periods of time, wherein each first period of time is separated from each second period of time by at least one third period of time, wherein the DC voltage levels in at least one first period of time, at least one second period of time, and at least one third period of time are different from each other; and one or more liquid crystal capacitors each of which is for being charged by a voltage difference between the common voltage and a data voltage.

According to another aspect of the present invention, there is provided a method of driving a liquid crystal display, the method comprising: providing a common voltage which is a direct-current (DC) voltage level in each of a plurality of first periods of time, in each of a plurality of second periods of time, and in each of a plurality of third periods of time, wherein each first period of time is separated from each second period of time by at least one third period of time, wherein the DC voltage levels in at least one first period of time, at least one second period of time, and at least one third period of time are different from each other; providing a data voltage; and charging one or more liquid crystal capacitors by a voltage difference between the common voltage and a data voltage.

### BRIEF DESCRIPTION OF THE DRAWINGS

FIG. 1 is a block diagram of a liquid crystal display according to some embodiments of the present invention;

FIG. 2 is a circuit diagram of one pixel in some embodiments of the liquid crystal display of FIG. 1;

FIGS. 3A and 3B are timing diagrams of the common voltage in some embodiments of the liquid crystal display of FIG. 1;

FIG. 4 is a is a timing diagram of the common voltage and a data voltage in some embodiments of the liquid crystal display of FIG. 1;

FIG. 5 is a conceptual diagram explaining the operation of some embodiments of the liquid crystal display of FIG. 1;

FIG. 6 is a block diagram of a common voltage providing unit in some embodiments of the liquid crystal display of FIG. 1;

FIG. 7 is a block diagram of another voltage providing unit in some embodiments of the liquid crystal display of FIG. 1; and

FIG. 8 is a timing diagram of voltage levels and the common voltage in some embodiments of FIG. 7.

### DESCRIPTION OF SOME EMBODIMENTS OF THE INVENTION

The embodiments described in this section are provided for illustration and do not limit the invention. The invention is defined by the appended claims.

It will be understood that when an element or layer is referred to as being “on,” “connected to” or “coupled to” another element or layer, then intervening elements or layers may be present. In contrast, when an element is referred to as being “directly on,” “directly connected to” or “directly coupled to” another element or layer, then there are no intervening elements or layers present. Like numbers refer to like elements throughout. As used herein, the term “and/or” includes any and all combinations of one or more of the associated listed items.

Terms like “first”, “second”, etc. may be used herein to distinguish one element from another. Such terms are mere reference labels that are interchangeable and do not limit the invention.

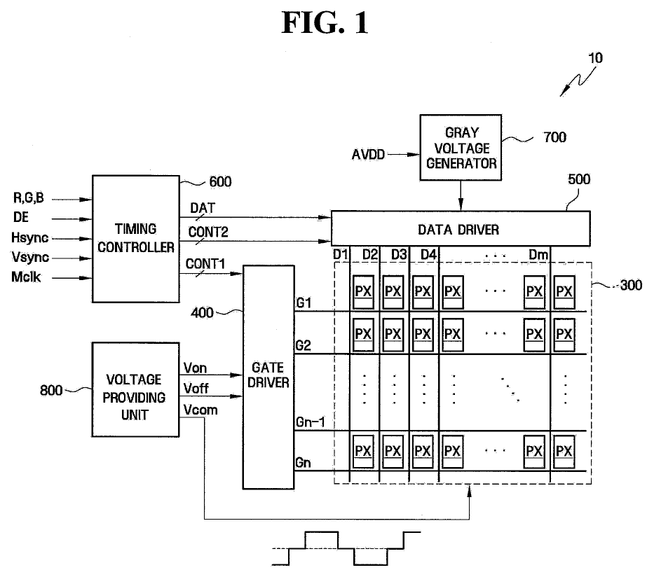

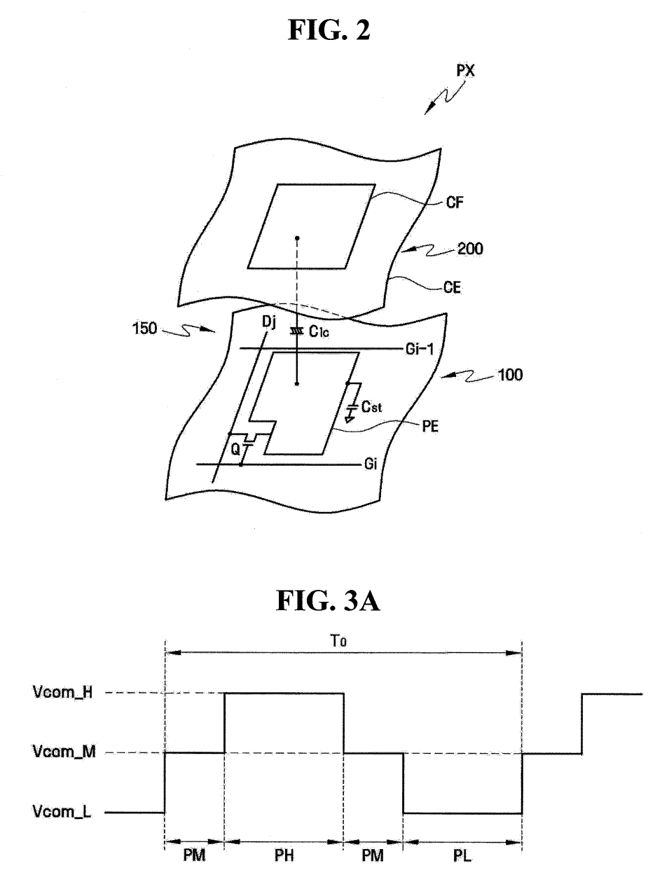

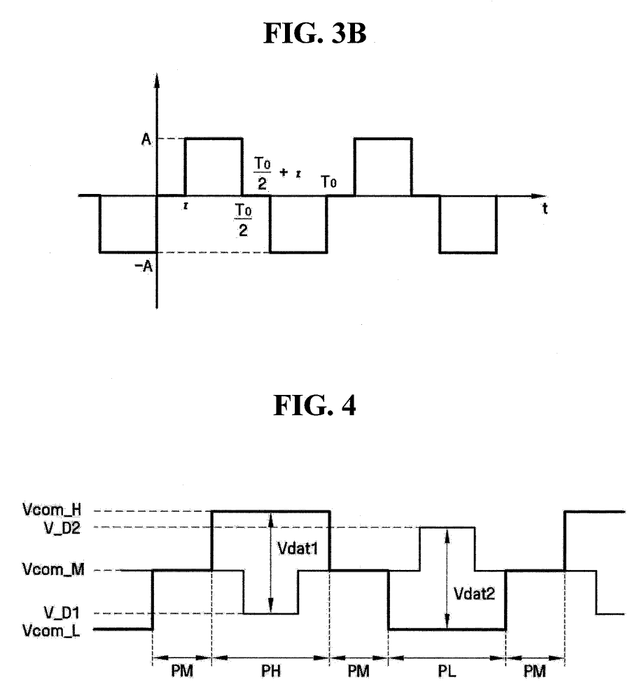

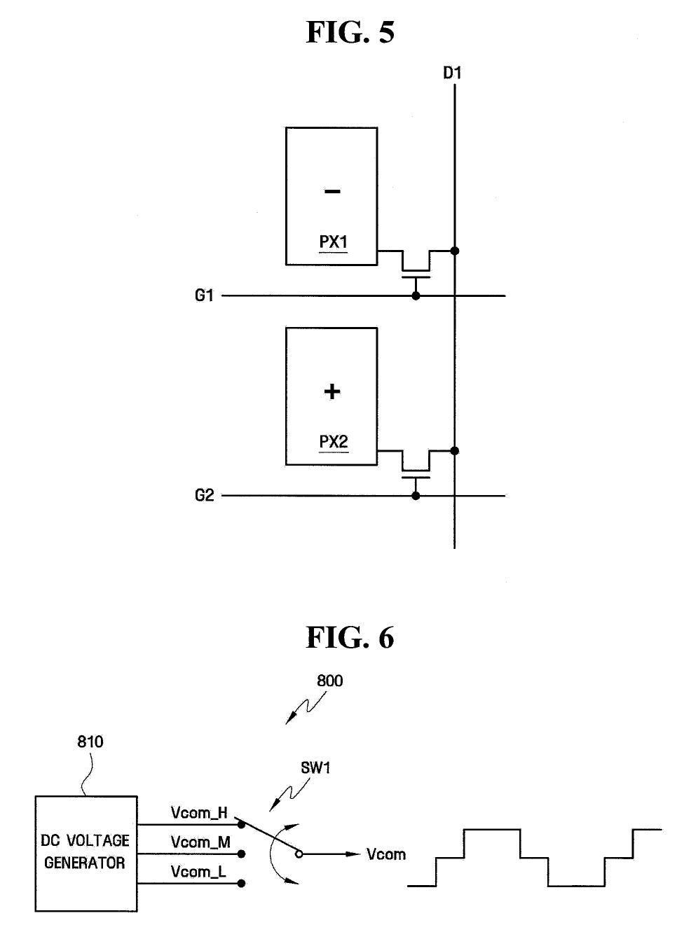

One embodiment of the present invention will now be described with reference to FIGS. 1 through 6. FIG. 1 is a block diagram of a liquid crystal display according to this embodiment, FIG. 2 is a circuit diagram of one pixel of the liquid crystal display of FIG. 1, FIGS. 3A and 3B are timing diagrams of the common voltage in the display of FIG. 1, FIG. 4 is a timing diagram of the common voltage and the data voltage, FIG. 5 is a conceptual diagram explaining the operation of the liquid crystal display shown in FIG. 1, and FIG. 6 is a block diagram of a voltage providing unit shown in FIG. 1.

FIG. 1 shows a liquid crystal display 10 which includes a liquid crystal panel 300, a gate driver 400, a data driver 500, a timing controller 600, a voltage providing unit 800, and a gray voltage generator 700. The driver 400, the data driver 500, and the timing controller 600 may or may not be incorporated into a single chip.

The liquid crystal panel 300 includes signal lines G1˜Gn and D1˜Dm, and pixels PX connected thereto as seen in FIG. 2 and arranged substantially in a matrix.

The signal lines G1˜Gn are gate lines for transmitting gate signals. The signal lines D1˜Dm are data lines for transmitting data signals. The gate lines G1˜Gn extend substantially in a row direction and are substantially parallel to each other, and data lines D1˜Dm extend substantially in a column direction and are substantially parallel to each other.

The gate driver 400 receives the gate-on voltage Von and the gate-off voltage Voff from the voltage generator 800, and provides these voltages to the gate lines G1˜Gn. More particularly, the gate driver 400 sequentially provides the gate on voltage Von to the gate lines G1˜Gn in response to gate control signals CONT1 from the timing controller 600.

The data driver 500 receives image data DAT and data control signals CONT2 from the timing controller 600. The data driver 500 selects “gray” voltages, i.e. voltages needed to display desired luminance levels. The selected gray voltages correspond to the respective image data DAT. The data driver 500 applies the selected voltages to the corresponding data lines D1˜Dm.

The aforementioned gate control signals CONT1, which control the operation of the gate driver 400, include a vertical start signal indicating the start of the operation of the gate driver 400 in displaying a frame, a gate clock signal determining the output timing of the gate-on voltage, an output enable signal determining the pulse width of the gate-on voltage, and so on. The data control signals CONT2, which control the operation of the data driver 500, include a horizontal start signal for starting the operation of the data driver 500 in displaying a frame, an output enable signal for enabling the output of the data voltages, and so on.

The gray voltage generator 700 includes a voltage divider formed by resistors connected in series between a terminal receiving a driving voltage AVDD and a ground terminal. The gray-scale voltage generator 700 thus generates the gray-scale voltages by dividing the driving voltage AVDD. The invention is not limited to this type of gray voltage generator however.

The timing controller 600 receives input image signals R, G, and B and external clock signals from an external graphics controller (not shown). The external clock signals are control signals which may include, for example, a data enable signal DE, a vertical synchronization signal Vsync, a horizontal synchronization signal Hsync, a main clock MCLK, and so on. The data enable signal DE is maintained at a high level while the input image signals R, G, and B are received. The data enable signal DE thus indicates that the signals provided by the external graphic controller (not shown) are the image signals R, G, and B. The vertical synchronization signal Vsync indicates a frame start. The horizontal synchronization signal indicates the start of processing a gate line. The main clock signal Mclk is a clock signal synchronizing all the other signals used by the liquid crystal display 10.

The timing controller 600 receives the input image signals R, G and B, generates image data DAT, and outputs the image data to the data driver 500. In addition, based on the external clock signals (such as the vertical synchronization signal Vsync, the horizontal synchronization signal Hsync, the main clock MCLK, the data enable signal DE, and so on), the timing controller 600 generates and outputs internal clock signals, that is, gate control signals CONT1 and data control signals CONT2.

As shown in FIG. 2, each pixel PX of the liquid crystal panel 300 includes a liquid crystal capacitor Clc and a storage capacitor Cst. The liquid crystal capacitor Clc is formed by a pixel electrode PE provided in a first display panel 100, a common electrode CE provided in a second display panel 200, and a liquid crystal layer disposed between the two display panels 100 and 200. Optionally, a color filter CF may be formed in the second display panel 200. A switching element Q is connected to the respective gate line Gᵢ(i=1˜n), the respective data line Dⱼ(j=1˜m), and the pixel electrode PE. The storage capacitor Cst is omitted in some embodiments.

The common electrode CE is supplied with the common voltage Vcom provided by the voltage providing unit 800. The pixel electrode PE is supplied with the data voltage provided by the data driver 500 via the data line Dⱼ. The liquid crystal capacitor Clc is charged to the voltage difference between the common voltage Vcom and the data voltage to display an image.

The voltage providing unit 800 generates the gate-on voltage Von, the gate-off voltage Voff and the common voltage Vcom; provides the gate-on voltage Von and the gate-off voltage Voff to the gate driver 400; and provides the common voltage Vcom to the common electrode CE shown in FIG. 2.

The common voltage Vcom is a periodic signal with a period T₀ as illustrated in the timing diagram of FIG. 3A. Each period T₀ includes one or more first voltage periods PH, one or more second voltage periods PL, and one or more third voltage periods PM. In each first voltage period PH, the common voltage Vcom is at a first direct-current (DC) voltage level Vcom_H. In each second voltage period PL, the common voltage Vcom is at a second DC voltage level Vcom_L. In each third voltage period PM, the common voltage Vcom is at a third DC voltage level Vcom_M. The voltage levels Vcom_H, Vcom_M, Vcom_L are different from each other. In this embodiment, the first and second voltage periods PH and PL alternate with each other, and a third voltage period PM is inserted between each two neighboring first and second voltage periods PH, PL.

The common voltage Vcom can be chosen to reduce audible noise as will now be described with reference to FIGS. 3A and 3B.

In the embodiment of FIG. 3B, the common voltage Vcom is a periodic function having an amplitude of 2A. Vcom_H=Vcom_M+A, and Vcom_L=Vcom_M−A. The symbol τ denotes the length of each third voltage period PM. In some embodiments, 0≦τ≦(T₀/2). The periodic function Vcom can be represented as the sum of the fundamental wave and its harmonics using a Fourier series. The fundamental frequency (i.e. the frequency of the fundamental wave) is the inverse of the period, i.e. is 1/T₀, and the harmonics' frequencies are k/T₀ where k is a natural number greater than one.

The audible band is from about 20 Hz to about 20 kHz. Assuming that the frequency 1/T₀ of the common voltage Vcom is between about 10 kHz and about 14 kHz, the fundamental frequency falls into the audible band but the harmonics of the fundamental frequency do not. Accordingly, the audible noise generated by the common voltage Vcom can be reduced by reducing the amplitude of the fundamental wave.

More particularly, denoting w₀=2π/T₀, the coefficient al of the fundamental wave of the common voltage Vcom of FIG. 3B can be expressed as follows:

$$\begin{matrix}{a}_{1} = \frac{1}{{T}_{0}} {\int }_{0}^{{T}_{0}} x ( t ) {e}^{- j {w}_{0} t} d t \\ = \frac{A}{{T}_{0}} ( {\int }_{τ}^{\frac{{T}_{0}}{2}} {e}^{- j {w}_{0} t} d t - {\int }_{\frac{{T}_{0}}{2} + τ}^{{T}_{0}} {e}^{- j {w}_{0} t} d t ) \\ = - \frac{A}{π} j ( {e}^{- j {w}_{0} τ} + 1 )\end{matrix} \qquad ( 1 )$$

Therefore the amplitude of the fundamental wave is

$$\vert {a}_{1} \vert = \frac{A}{π} \sqrt{2 ( cos ( {w}_{0} τ ) + 1 )} \qquad ( 2 )$$

The coefficient a₁ of the fundamental wave is thus a function of the amplitude A and τ. Therefore, the audible noise generated by the common voltage Vcom can be decreased by choosing the amplitude A and τ so as to reduce the amplitude |a₁| of the fundamental wave. More particularly, it is clear from the equation (2) the fundamental wave's amplitude decreases with cos(w₀τ). Accordingly, in some embodiments, τ is chosen to make cos(w₀τ) small. When τ is 0, the value cos(w₀τ) is maximal. Therefore, in some embodiments τ is not 0. For example, τ may be T₀/4, in which case cos(w₀τ) is zero.

Thus, as shown in FIG. 3A, the common voltage Vcom is at levels Vcom_H, Vcom_L, Vcom_M in respective first through third voltage periods PH, PL, PM. The first and second voltage periods PH and PL alternate with each other, and a third voltage period PM is inserted between each two neighboring first and second voltage periods PH and PL. The third DC voltage level Vcom_M can be the mean value of the first DC voltage level Vcom_H and the second DC voltage level Vcom_L. The voltage providing unit 800 providing the common voltage Vcom is described below with reference to FIG. 6.

Now the operation of the liquid crystal display 10 will be described with reference to FIGS. 4 and 5. FIG. 5 illustrates two exemplary pixels (“first” and “second” pixels) PX1, PX2 connected to the data line D1 and the respective gate lines (“first” and “second” gate lines) G1, G2. The remaining pixels operate in a similar manner.

Referring to FIG. 4, each period 1H is one horizontal period (in which a row of pixels is driven), and this period may equal in duration to one half of the period T₀ of common voltage Vcom. Thus, the two periods 1H in FIG. 4 may form one period T₀. In this period T₀, the first voltage period PH occurs during the first horizontal period 1H when the gate-on voltage Von is applied to the first gate line G1 (i.e. when the first gate G1 is activated). The second voltage period PL occurs during the second horizontal period 1H when the gate-on voltage Von is applied to the second gate line G2. In the periods PH and PL, respective first and second data voltages V_D1 and V_D2 are applied to the data line D1 during the activation of the respective first and second gate lines G1 and G2. In the first voltage period PH, the first data voltage V_D1 and the first DC voltage Vcom_H may have respective different polarities with respect to the third DC voltage Vcom_M. In the second voltage period PL, the second data voltage level V_D2 and the second DC voltage level Vcom_L may have respective different polarities with respect to the third DC voltage level Vcom_M. For example, in one embodiment the first data voltage V_D1 has negative polarity with respect to the third DC voltage level while the voltage Vcom is at the positive polarity level Vcom_H with respect to the third DC voltage level Vcom_M. The second data voltage V_D2 has positive polarity with respect to the third DC voltage level Vcom_M while the voltage Vcom is at the negative polarity level Vcom_L with respect to the third DC voltage level Vcom_M.

Thus, the first pixel PX1 receives the first data voltage V_D1 supplied through the data line D1 during the first voltage period PH. The second pixel PX2 receives the second data voltage V_D2 supplied through the data line D1 during the second voltage period PL. Therefore, in the first voltage period PH, the liquid crystal capacitor of the first pixel PX1 charges to the voltage difference Vdat1 between the first data voltage V_D1 and the first DC voltage Vcom_H. In the second voltage period PL, the liquid crystal capacitor of the second pixel PX2 charges to the voltage difference Vdat2 between the second data voltage V_D2 and the second DC voltage Vcom_L. In this manner, the first and second pixels PX1 and PX2 display images based on the respective voltage differences Vdat1 and Vdat2. The liquid crystal capacitor of the first pixel PX1 and the liquid crystal capacitor of the second pixel PX2 charge during the respective first and second voltage periods PH and PL. The first and second voltage periods PH and PL may be substantially equal in duration.

Now the voltage providing unit 800 of FIG. 1 will be described in more detail with reference to FIG. 6. FIG. 6 is a block diagram of the voltage providing unit. The voltage providing unit 800 of FIG. 6 includes a direct-current (DC) voltage generator 810 and a switching unit SW1.

The DC voltage generator 810 generates and outputs the first to third DC voltages Vcom_H, Vcom_L, and Vcom_M. The switching unit SW1 selects one of the first to third DC voltages Vcom_H, Vcom_L, and Vcom_M and outputs the selected voltage as the common voltage Vcom shown in FIG. 3A. The switching unit SW1 adjusts the duration of each of the first to third voltage periods PH, PL, and PM in response to a control signal (not shown) to minimize audible noise.

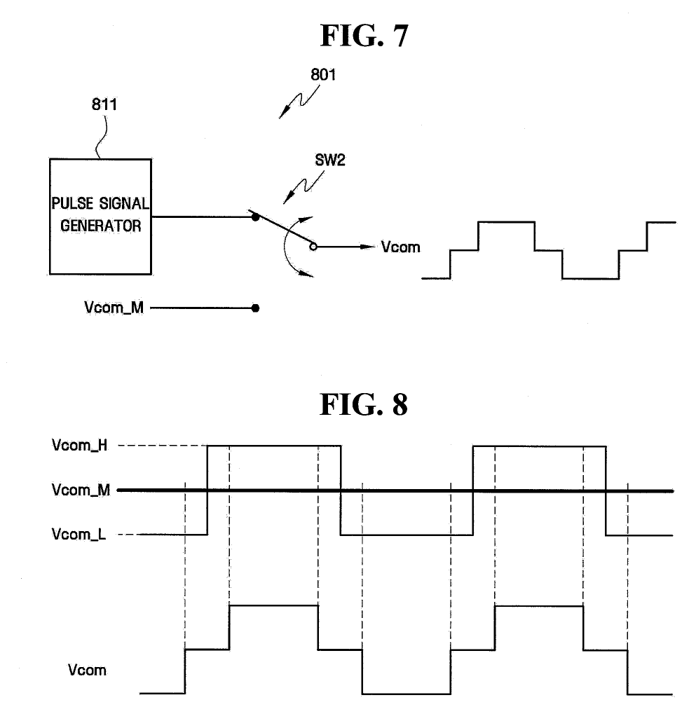

A voltage providing unit of a liquid crystal display according to another embodiment of the present invention will be described with reference to FIGS. 7 and 8. FIG. 7 is a block diagram of this voltage unit 801, and FIG. 8 is a timing diagram.

As shown in FIG. 7, the voltage providing unit 801 includes a pulse signal generator 811 and a switching unit SW2.

As shown in FIG. 8, the pulse signal PULSE provided by the pulse signal generator 811 alternates between the first DC voltage level Vcom_H and the second DC voltage level Vcom_L. The switching unit SW2 selects either the third DC voltage Vcom_M or the pulse signal PULSE and outputs the selected voltage as the common voltage Vcom shown in FIG. 3A. The switching unit SW2 adjusts the duration of each of the first to third voltage periods PH, PL, and PM in response to a control signal (not shown) to minimize audible noise.

The invention is not limited to the exemplary embodiments discussed above but is defined by the appended claims.

What is claimed is:

1. A liquid crystal display comprising:
a voltage providing unit for providing a common voltage which is a direct-current (DC) voltage level in each of a plurality of first periods of time, in each of a plurality of second periods of time, and in each of a plurality of third periods of time, wherein each first period of time is separated from each second period of time by at least one third period of time, wherein the DC voltage levels in at least one first period of time, at least one second period of time, and at least one third period of time are different from each other; and
one or more liquid crystal capacitors each of which is for being charged by a voltage difference between the common voltage and a data voltage.

2. The liquid crystal display of claim 1, wherein the DC voltage level in each first period of time is a predefined first DC voltage level, the DC voltage level in each second period of time is a predefined second DC voltage level, and the DC voltage level in each third period of time is a predefined third DC voltage level, wherein the first, second and third DC voltage levels are different from each other.

3. The liquid crystal display of claim 2, wherein the third DC voltage level is substantially a mean value of the first DC voltage level and the second DC voltage level.

4. The liquid crystal display of claim 2, wherein the data voltage is for alternating between positive and negative polarities with respect to the third DC voltage level.

5. The liquid crystal display of claim 2, wherein each liquid crystal capacitor is for being charged by a voltage difference between the common voltage and the data voltage in each of one or more of the first and second periods of time.

6. The liquid crystal display of claim 2, wherein each liquid crystal capacitor is for being charged by the data voltage and the common voltage in each of one or more of the first and second periods of time in which the common voltage is at the DC level of an opposite polarity than the data voltage with respect to the third DC voltage level.

7. The liquid crystal display of claim 1, wherein the common voltage is a periodic signal, and the voltage providing unit is for adjusting a duration of each of the first through third periods of time.

8. The liquid crystal display of claim 7, wherein all of the first and second periods of time are substantially equal to each other in duration.

9. The liquid crystal display of claim 1, wherein the common voltage is a periodic signal, and a duration of each third period of time is substantially one-fourth of a period of the common voltage.

10. The liquid crystal display of claim 1, wherein the common voltage providing unit comprises:
a direct-current (DC) voltage generator for generating the first, second, and third DC voltage levels; and
a switching unit for selectively outputting one of the first, second, and third DC voltages.

11. The liquid crystal display of claim 1, wherein the common voltage providing unit comprises:
a pulse signal generator for generating a pulse signal that alternates between the first and second DC voltage levels; and
a switching unit for selectively outputting the pulse signal or the third DC voltage level.

12. A liquid crystal display of claim 1, wherein the common voltage has a stepwise waveform.

13. A method of driving liquid crystal display, the method comprising:
providing a common voltage which is a direct-current (DC) voltage level in each of a plurality of first periods of time, in each of a plurality of second periods of time, and in each of a plurality of third periods of time, wherein each first period of time is separated from each second period of time by at least one third period of time, wherein the DC voltage levels in at least one first period of time, at least one second period of time, and at least one third period of time are different from each other;
providing a data voltage; and
charging one or more liquid crystal capacitors by a voltage difference between the common voltage and a data voltage.

14. The method of claim 13, wherein the DC voltage level in each first period of time is a predefined first DC voltage level, the DC voltage level in each second period of time is a predefined second DC voltage level, and the DC voltage level in each third period of time is a predefined third DC voltage level, wherein the first, second and third DC voltage levels are different from each other.

15. The method of claim 14, wherein the third DC voltage level is substantially a mean value of the first DC voltage level and the second DC voltage level.

16. The method of claim 14, wherein the data voltage alternates between positive and negative polarities with respect to the third DC voltage level.

17. The method of claim 14, wherein each liquid crystal capacitor is charged by a voltage difference between the common voltage and the data voltage in each of one or more of the first and second periods of time.

18. The method of claim 17, wherein each liquid crystal capacitor is charged by the data voltage and the common voltage in each of one or more of the first and second periods of time in which the common voltage is at the DC level of an opposite polarity than the data voltage with respect to the third DC voltage level.

19. The method of claim 17, wherein providing the common voltage comprises adjusting a time duration of each of the first through third periods of time.

20. The method of claim 19, wherein all of the first and second periods of time are substantially equal to each other in duration.
